(19) United States
(12) Patent Application Publication
(10) Pub. No.: US 2024/0100422 A1
(43) Pub. Date: Mar. 28, 2024

(54) Resource Use Orchestration for Multiple Application Instances

(71) Applicants: Advanced Micro Devices, Inc, Santa Clara, CA (US); ATI Technologies ULC, Markham (CA)

(72) Inventors: Yinan Jiang, Richmond Hill (CA); HaiJun Chang, SHANGHAI (CN); GuoQing Zhang, SHANGHAI (CN)

(21) Appl. No.: 17/955,266

(22) Filed: Sep. 28, 2022

(51) Int. Cl. A63F 13/335; A63F 13/352; A63F 13/358

(52) U.S. Cl. CPC A63F 13/335; A63F 13/352; A63F 13/358

(57) ABSTRACT

Resource use orchestration for multiple application instances is described. In accordance with the described techniques, a time interval for accessing a resource is divided into multiple time slots. In one or more implementations, the resource is a graphics processing unit. Each of a plurality of containers associated with an application is assigned to one of the multiple time slots according to a disbursement algorithm. A respective signal offset is provided to each container based on an assigned time slot of the container. The provided signal offsets cause the plurality of containers to access the resource for the application in a predetermined order.

### BACKGROUND

Containers enable an application to be deployed in a standardized and shared way across multiple computing devices. For a gaming application, for instance, deploying the application via containers provides a gaming environment that is shareable by numerous computing devices, such that the users of the numerous computing devices are able to experience and affect the gaming environment in real-time or near-real-time. As an example, when user inputs are received from one computing device and affect the gaming environment (or a state of a game), the affected gaming environment is propagated across the containers to one or more of the other computing devices in real-time or near-real time, so that the user of the one computing device and the users of the one or more other computing devices experience the affected gaming environment at substantially a same time. By way of example, if user inputs are received via one computing device to move an avatar to a different location in a gaming environment, then the movement of the avatar is propagated across the containers, so that the avatar moves at substantially a same time for the other computing devices. This allows users (e.g., many users) to interact with one another in a shared gaming environment. In order to run instances of the application, the containers utilize underlying resources, e.g., graphics processing units (GPUs). For example, a gaming application may utilize a GPU to render frames for the gaming application. In conventional systems, multiple containers (e.g., gaming instances) will race for resource bandwidth, e.g., GPU render bandwidth from the GPU.

### BRIEF DESCRIPTION OF THE DRAWINGS

FIG. 1 is a block diagram of a non-limiting example system having a container orchestrator that orchestrates access by multiple containers to a resource.

FIG. 2 depicts a block diagram of a non-limiting example of determining a time interval for accessing a resource by a plurality of containers for an application.

FIG. 3 depicts a block diagram of a non-limiting example of dividing a time interval for accessing a resource into multiple time slots.

FIG. 4 depicts a block diagram of a non-limiting example of assigning a container to one of the multiple time slots according to the disbursement algorithm.

FIG. 5 depicts a block diagram of a non-limiting example of assigning an additional container to a different one of the multiple time slots according to the disbursement algorithm.

FIG. 6 depicts a block diagram of another non-limiting example of assigning an additional container to a different one of the multiple time slots according to the disbursement algorithm.

FIG. 7 depicts a block diagram of a non-limiting example of assigning multiple additional containers to different respective time slots according to the disbursement algorithm.

FIG. 8 depicts a block diagram of a non-limiting example of assignment of multiple containers to respective time slots of a time interval according to the disbursement algorithm.

FIG. 9 depicts a block diagram of a non-limiting example of a disbursement algorithm.

FIG. 10 depicts a block diagram of a non-limiting example of receiving render commands from multiple containers for an application in a predetermined order.

FIG. 11 depicts a block diagram of a non-limiting example of receiving render commands from multiple containers for an application at random times.

FIG. 12 depicts a procedure in an example implementation of orchestrating access to a resource by a plurality of containers for an application.

FIG. 13 depicts a procedure in an example implementation of orchestrating access by a plurality of containers of an application to a graphics processing unit.

### DETAILED DESCRIPTION

Overview

In conventional systems, multiple containers (e.g., gaming instances) will race for resource bandwidth, e.g., GPU render bandwidth from the GPU. However, in these conventional systems, the timing of requests for a resource from multiple containers is not controlled which causes the requests to be received by the resource in a random order. This random order of requests causes the resource to be overloaded at times resulting in a long render latency, and idle at other times while the resource waits for requests. Due to this, the conventional systems are unable to guarantee quality of service for each container in a group of containers that access the resource.

To overcome these problems, resource use orchestration for multiple application instances is described. In accordance with the described techniques, access to a resource is orchestrated for a plurality of containers for an application. To do so, a container orchestrator provides different signal offsets to each the of the plurality of containers. The provided signal offsets specify an offset from a baseline time or signal, and control when the plurality of containers access the resource in connection with running the application. For a group of containers accessing a same resource (e.g., an individual graphics processing unit), for instance, the container orchestrator provides a different signal offset to each container.

By providing a different signal offset to each container, the container orchestrator controls the containers to access the resource at different times relative to the baseline time or signal, such as in a predetermined order. Due to the predetermined order, the container orchestrator causes the resource to be accessed at predetermined times, rather than randomly as is the case with conventional systems. By orchestrating the use of the resource in this way, the container orchestrator regulates when the resource is used (e.g., performing operations) and when the resource operates in a reduced or idle state. Thus, by controlling access by the containers to the resources according to a predetermined order, the container orchestrator is able to regulate the resources so that they do not switch to reduced-power or idle states, or, if they do switch, then the resources can be switched back to an operational state in a suitable amount of time to avoid latencies. Moreover, by allocating a predetermined amount of time for each command and by allocating the amount of time at the predetermined repeated time interval, the system guarantees a quality of service of the underlying resources to the containers. Due to this, the resource consistently serves each of the containers with a minimal (but expected) amount of delay, if any.

In some aspects, the techniques described herein relate to a method for orchestrating access to a resource for a plurality of containers for an application, the method including: dividing a time interval for accessing the resource into multiple time slots, assigning each of the plurality of containers to one of the multiple time slots according to a disbursement algorithm, and providing, to each container, a respective signal offset based on an assigned time slot of the container, wherein provided signal offsets cause the plurality of containers to access the resource for the application in a predetermined order.

In some aspects, the techniques described herein relate to a method, further including assigning the plurality of containers to the resource based on computing devices of the plurality of containers having a same refresh rate or frame per second criteria.

In some aspects, the techniques described herein relate to a method, further including determining the time interval for accessing the resource based on the refresh rate.

In some aspects, the techniques described herein relate to a method, wherein the dividing the time interval into multiple time slots is based on a maximum number of containers that can access the resource during the time interval.

In some aspects, the techniques described herein relate to a method, wherein the provided signal offsets cause the plurality of containers to access the resource by sequentially submitting commands to the resource.

In some aspects, the techniques described herein relate to a method, wherein the resource executes the commands in substantially real time as the commands are submitted to the resource.

In some aspects, the techniques described herein relate to a method, wherein the provided signal offsets specify an offset from a baseline signal.

In some aspects, the techniques described herein relate to a method, wherein the disbursement algorithm causes the plurality of containers to be assigned to evenly spaced time slots over the time interval.

In some aspects, the techniques described herein relate to a method, wherein the disbursement algorithm is configured based on binary tree.

In some aspects, the techniques described herein relate to a method, wherein each of the multiple time slots is associated with an offset factor, and wherein the signal offset is determined based on the offset factor.

In some aspects, the techniques described herein relate to a system including: a resource for an application, and a container orchestrator that orchestrates access to the resource by a plurality of containers for the application by providing, to each container of the plurality of containers, a respective signal offset, wherein provided signal offsets cause the plurality of containers to access the resource for the application in a predetermined order.

In some aspects, the techniques described herein relate to a system, wherein the resource includes a graphics processing unit.

In some aspects, the techniques described herein relate to a system, wherein the application includes a gaming application.

In some aspects, the techniques described herein relate to a system, wherein the provided signal offsets specify an offset from a baseline signal.

In some aspects, the techniques described herein relate to a system, wherein the provided signal offsets cause the plurality of containers to access the resource by sequentially submitting commands to the resource, and wherein the resource executes the commands in substantially real time as the commands are submitted to the resource.

In some aspects, the techniques described herein relate to a method for orchestrating access by a plurality of containers to a graphics processing unit to render an application, the method including: assigning each of the plurality of containers of the application to a time slot for accessing the graphics processing unit, and providing, to each container, a respective signal offset based on an assigned time slot of the container, wherein provided signal offsets cause the plurality of containers to submit render commands to the graphics processing unit in a predetermined order.

In some aspects, the techniques described herein relate to a method, wherein the assigning further includes dividing a time interval for accessing the graphics processing unit into multiple time slots.

In some aspects, the techniques described herein relate to a method, wherein providing the respective signal offset causes each container to store the signal offset with configuration data of the container.

In some aspects, the techniques described herein relate to a method, wherein application includes a gaming application.

In some aspects, the techniques described herein relate to a method, wherein the provided signal offsets define a vertical synchronization signal for each respective container.

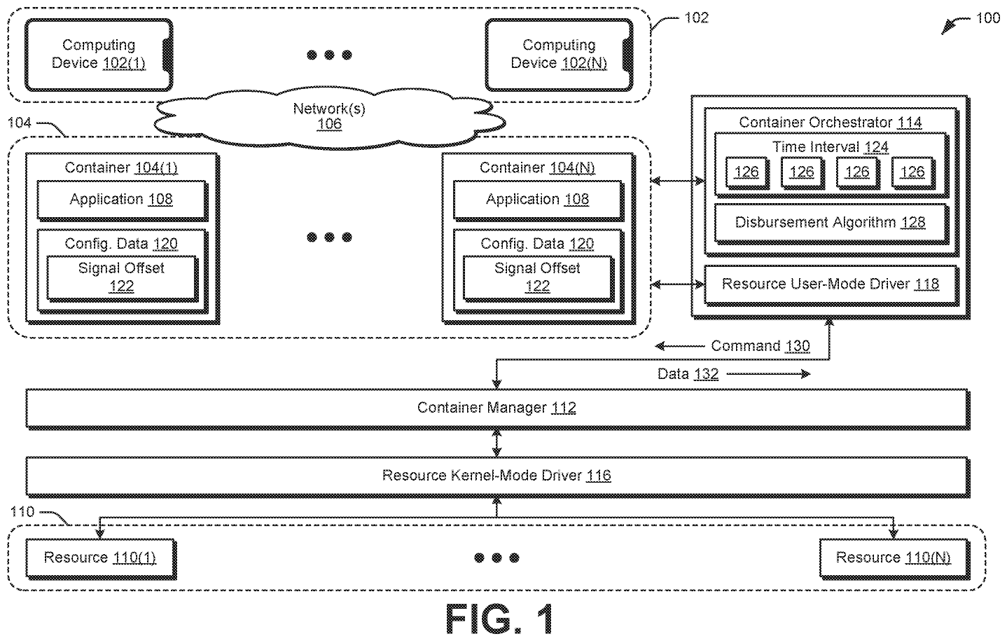

FIG. 1 is a block diagram of a non-limiting example system 100 having a container orchestrator that orchestrates access by multiple containers to a resource. The system 100 includes computing devices 102 and containers 104. The system also includes one or more networks 106, an example of which is the Internet. The computing devices 102 communicate over the one or more networks 106 with the containers 104. Here, examples of individual computing devices 102 include computing device 102(1) and computing device 102(N) and examples of respective containers include container 104(1) and container 104(N), where ‘N’ corresponds to any positive integer, e.g., 1 or greater. This represents that the described techniques are operable in connection with a plurality of computing devices 102 and a respective plurality of containers 104, such as by launching (or otherwise instantiating) one container 104 for one computing device 102.

Although depicted as mobile phones in the illustrated example, the computing devices 102 may be configured as any of a variety of types of computing device, and the computing devices 102 may be different one from another, in accordance with the described techniques. In one example, for instance, the computing device 102(1) may both correspond to a same type of computing device, e.g., the same type of mobile phone. In a different example, though the computing device 102(1) may correspond to a first type of computing device and the computing device 102(N) may correspond to a second, different type of computing device. Examples of computing devices include, but are not limited to, mobile devices (e.g., mobile phones and tablets), laptop computers, desktop computers, wearables (e.g., smart watches), virtual or augmented reality devices (e.g., smart glasses or virtual reality headsets), servers, gaming consoles, gaming controllers with displays, set top boxes, and so forth. Thus, the individual computing devices 102 may range from lower resource devices with limited memory and/or processing resources to higher resource devices with substantial memory and processor resources.

In accordance with the described techniques, the containers 104 each run an instance of an application 108 and, over the network 106, provide (e.g., stream) content of the application 108 (e.g., rendered frames) to a respective computing device 102. For instance, the container 104(1) provides content of its instance of the application 108 over the network 106 to the computing device 102(1), and the container 104(N) provides content of its instance of the application 108 over the network to the computing device 102(N). Examples of the application 108 include but are not limited to a gaming application (e.g., a massively multiplayer online game), a virtual or augmented reality application, a synchronized content streaming application, and a video conferencing application, to name just a few.

In addition, the computing devices 102 receive one or more of a variety of user inputs (e.g., touch, non-touch gesture, voice command, via a keyboard, via a stylus, via a joystick or gaming controller, and so on) via one or more user interfaces to interact with the application 108. The computing devices 102 communicate the user inputs (or signals indicative of the user inputs) over the network 106 to the containers 104, which process the user inputs and modify a state of the application 108 according to the user input, such as by moving an avatar to a different location in a gaming environment or causing the avatar to perform some action in the gaming environment, for instance.

In one or more variations, use of the containers 104 enables the application 108 to be deployed in a standardized and shared way across multiple and different computing configurations, such as for different computing devices having different resources. In variations where the application 108 is a gaming application, for instance, deploying the application 108 via the containers 104 enables the system 100 to provide a gaming environment that is shareable by numerous computing devices 102, such that the users of the numerous computing devices 102 are able to experience and affect the gaming environment in real-time or near-real-time. In other words, when user inputs are received from one computing device 102 and affect the gaming environment (or a state of a game), the affected gaming environment is propagated across the containers 104 to one or more of the other computing devices 102 in real-time or near-real time, so that the user of the one computing device 102 and the users of the one or more other computing devices 102 experience the affected gaming environment at substantially a same time. By way of example, if user inputs are received via one computing device 102 to move an avatar to a different location in a gaming environment, then the movement of the avatar is propagated across the containers 104, so that the avatar moves at substantially a same time for the other computing devices 102. This allows users (e.g., many users) to interact with one another in a shared gaming environment.

In order to run instances of the application 108, the containers 104 utilize underlying resources 110, e.g., computer hardware resources. Examples of the resources 110 include but are not limited to, processors (e.g., graphics processing units (GPUs), central processing units, accelerated processing units, and digital signal processors), memory, caches, and secondary storage. Alternatively or in addition, examples of the resources 110 include virtualized resources. In one or more implementations, the resources 110 correspond to a plurality of graphics processing units, such that resource 110(1) is an example of one graphics processing unit and resource 110(N) is an example of another graphics processing unit. In connection with the resources 110, ‘N’ corresponds to any positive integer, e.g., 1 or greater. This represents that the system 100 may include any number of the resources 110, e.g., any number of graphics processing units. Although two resources 110 are depicted in the illustrated example, in variations the system 100 includes one such resource, e.g., one graphics processing unit. In implementations where the application 108 is a gaming application and the resources 110 are graphics processing units, the system 100 uses the graphics processing units to render frames for the gaming application. The rendered frames are provided to a respective container 104 and then over the network 106 to the corresponding computing device 102.

In accordance with the described techniques, the system 100 also includes container manager 112 and container orchestrator 114, and is illustrated including resource kernel-mode driver 116 and resource user-mode driver 118. Broadly, these components enable the containers 104 to access the resources 110 in connection with running their instances of the application 108, in accordance with the described techniques. These components also enable the containers 104 to share an individual resource 110 in connection with running respective instances of the application 108. For example, the components enable multiple containers 104 to use a single graphics processing unit to render frames for their respective instances of a gaming application.

Although the illustrated example depicts one of each of the container manager 112, the container orchestrator 114, the resource kernel-mode driver 116, and the resource user-mode driver 118, in variations, the system includes different numbers of those components. By way of example and not limitation, in at least one variation, each of the containers 104 includes a respective resource user-mode driver 118, such that the number of resource user-mode drivers 118 of the system is the same as a number of containers 104 created. Alternatively or additionally, those components are included as part of and/or accessible by different portions of the system 100 than illustrated.

Broadly, the container manager 112 provides a framework and protocol for creating and managing the containers 104. By way of example and not limitation, the container manager 112 includes libraries, files (e.g., container images which are static files with executable code), and various code for creating and managing the containers 104. Examples of the container manager 112 include, but are not limited to, LXD and Docker. In accordance with the described techniques, the container orchestrator 114 operates in concert with the container manager 112 to create the containers 104 and then configure them appropriately to run their instance of the application 108 for the respective computing devices 102.

As part of creating the containers 104, for instance, the container orchestrator 114 provides configuration data 120 for each container 104. The container orchestrator 114 also provides a respective signal offset 122 for each container 104, which is stored in the configuration data 120, in one or more variations. The signal offsets 122 specify an offset from a baseline time or signal, and they control when the containers 104 access the resource 110 in connection with running the application 108. Although the container orchestrator 114 is depicted separately from the container manager 112 in the illustrated example, in one or more variations, the container manager 112 includes at least a portion of the container orchestrator 114.

For a group of containers 104 accessing a same resource 110 (e.g., an individual graphics processing unit), for instance, the container orchestrator 114 provides a different signal offset 122 to each container 104. With the signal offsets 122, the container orchestrator 114 indicates when the containers 104 are scheduled to access the resource 110. By providing a different signal offset 122 to each container 104, the container orchestrator 114 causes the containers 104 to access a resource 110 at different times relative to the baseline time or signal, such as in a predetermined order, as discussed in more detail below.

To provide the signal offsets 122, in one or more implementations, the container orchestrator 114 determines a time interval 124 for one or more operations to be performed for the containers 104 by the resources 110 on a repeated basis. Further, the container orchestrator 114 divides the time interval 124 into a plurality of time slots 126. In at least one variation, a number of time slots 126 into which the time interval is divided is based on an amount of time it takes the resource 110 to perform the one or more operations. In one or more implementations, the container orchestrator 114 assigns the containers 104 to the time slots 126 based on a disbursement algorithm 128. The signal offset 122 provided to a container 104 is based on the time slot 126 to which the container is assigned.

In one or more implementations, the containers 104 “access” a resource 110 by sending it one or more commands 130. One example of a command 130 is a command to a graphics processing unit (an example of a resource 110) to render a frame for a respective instance of the application 108. In the context of rendering frames for an application, in variations, a container 104 submits commands 130 to render a frame repeatedly, e.g., at a time interval that supports a refresh rate of a display device of a respective computing device 102. Responsive to a command 130, the resource 110 performs a corresponding operation, such as rendering a frame, updating a physics engine, updating a game state or state of a virtual environment, converting speech to text (e.g., for subtitles), and so forth. The resource 110 then outputs data 132, which is a result of the operation performed by the resources 110, and the data 132 is provided to the container 104 that submitted the command 130. Returning to the example of rendering a frame for a container 104, for instance, the resource 110 renders a frame based on the command 130 and outputs a rendered frame (e.g., an example of the data 132). The system 100 then provides the rendered frame to the container 104 that requested the frame be rendered (e.g., via a command 130), and the container 104 further provides the frame to the computing device 102 to which it corresponds.

In one or more implementations, the resource user-mode driver 118 is a component that controls and manages interfaces for the instances of the application 108 to interact with a resource 110. In a scenario where the resource 110 is a graphics processing unit, for instance, the resource user-mode driver 118 controls and manages interfaces for the instances of the application 108 to interact with the resource kernel-mode driver 116. In contrast, the resource kernel-mode driver 116 is a component that controls and manages for an operating system (not shown) to interact with a resource 110, such as a graphics processing unit. Continuing with the example scenario where the resource 110 is a graphics processing unit, the resource kernel-mode driver 116 controls and manages interfaces for an operating system (e.g., of one or more server devices) to interact with the graphics processing unit.

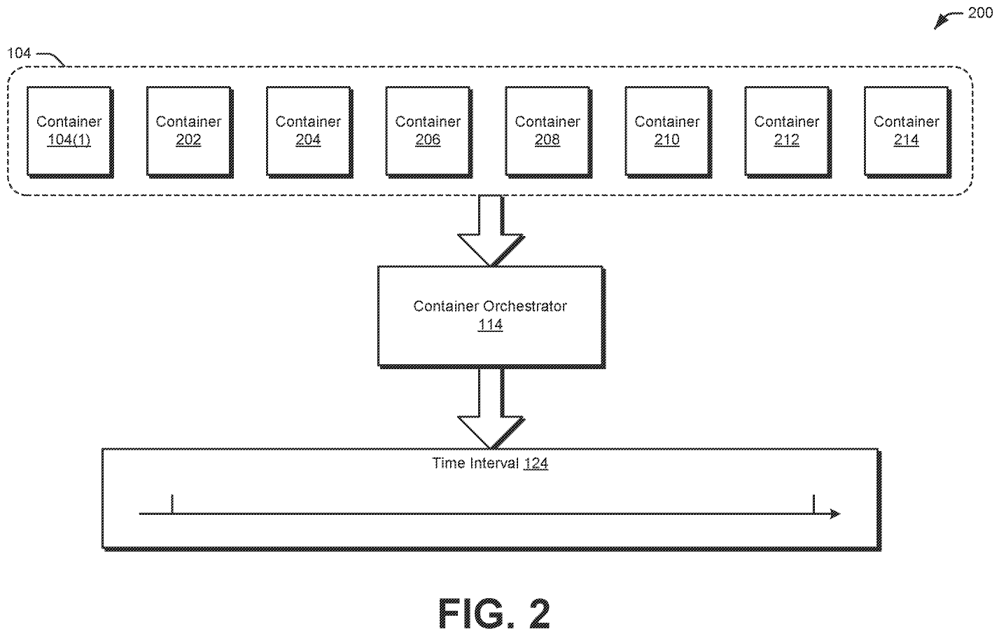

In the context of determining the signal offsets 122 so that the containers 104 submit commands 130 for a resource 110 in a predetermined order, consider the following discussion of FIGS. 2-9.

FIG. 2 depicts a block diagram of a non-limiting example 200 of determining a time interval for accessing a resource by a plurality of containers for an application.

The illustrated example 200 depicts a group of the containers 104, the container orchestrator 114, and the time interval 124. In this example 200 the group of containers 104 includes the container 104(1), container 202, container 204, container 206, container 208, container 210, container 212, and container 214. In accordance with the described techniques, the container orchestrator 114 determines the time interval 124 for the group of containers 104.

In one or more implementations, the container orchestrator 114 assigns containers 104 to a particular resource 110 (or it groups containers) based, in part, on sharing a frequency at which they use the data 132 produced by the resource 110 for respective instances of the application 108. The container orchestrator 114 determines the time interval 124 for a group of containers 104 based on the same frequency. Said another way, the container orchestrator 114 determines the time interval 124 for a group of containers 104 based on how often those containers need the data 132 from a resource 110 in order to maintain a threshold quality of service in connection with running the application 108.

In the context of rendering frames of the application 108, for instance, in one or more implementations, the container orchestrator 114 groups containers 104 based on a refresh rate of their respective computing devices 102. Alternatively or in addition, the container orchestrator 114 groups the containers 104 based on user a user selection of a refresh rate or frame per second criteria, e.g., the computing device 102 is 60 Hz and a user has selected to use 30 Hz to save bandwidth. To an individual resource 110 such as the resource 110(1) (e.g., a particular physical graphics processing unit), for example, the container orchestrator 114 assigns containers 104 that correspond to computing devices 102 using a same refresh rate or frame per second criteria, one computing device to another, (e.g., 30 Hz). To a second resource 110 such as the resource 110(N) (e.g., a separate physical graphics processing unit), the container orchestrator 114 assigns containers 104 that correspond to computing devices 102 using a different refresh rate, one computing device to another (e.g., 60 Hz). The container orchestrator 114 does not assign containers 104 that correspond to computing devices 102 using different refresh rates or frame per second criteria to a same resource 110—the container orchestrator 114 does not assign containers 104 that correspond to computing devices 102 using a 30 Hz refresh rate to a same graphics processing unit as containers 104 that correspond to computing devices 102 using a 60 Hz refresh rate.

Continuing with the frame-rending example, the container orchestrator 114 determines the time interval 124 for a group of the containers 104 based on how often those containers need the data 132 (e.g., a rendered frame) from the resource 110, which in this case is based on the refresh rate. To support a refresh rate of 30 Hertz, for instance, a container 104 requires 30 frames per second, or a rendered frame from the resource 110 approximately every 33.333 milliseconds. In this scenario, the container orchestrator 114 thus determines that the time interval 124 for the group of containers 104 is 33.333 milliseconds. To support a refresh rate of 60 Hertz, though, a container requires 60 frames per second, or a rendered frame from a resource 110 approximately every 16.667 milliseconds. In this different scenario, the container orchestrator 114 thus determines that the time interval 124 for the group of containers 104 is 16.667 milliseconds. Indeed, the container orchestrator 114 determines different time intervals 124 in various implementations, e.g., which are based on a frequency at which a group of containers 104 needs the data 132 from the resource 110 in order to maintain a threshold quality of service. In the context of dividing the time interval 124 into the time slots 126, consider the following example.

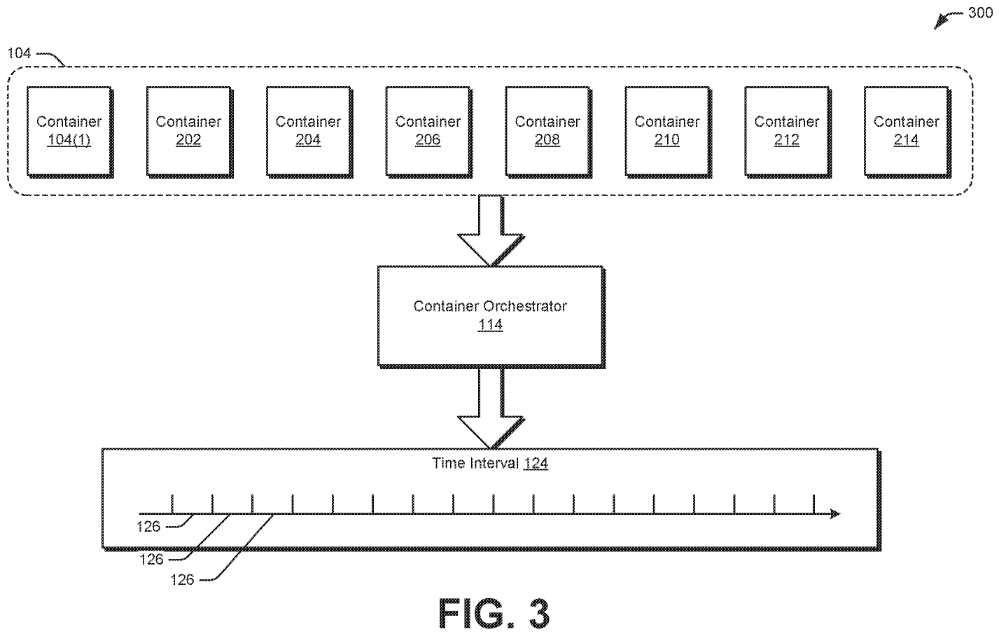

FIG. 3 depicts a block diagram of a non-limiting example 300 of dividing a time interval for accessing a resource into multiple time slots.

The illustrated example 300 depicts the group of the containers 104, the container orchestrator 114, and the time interval 124. In contrast to the time interval 124 depicted in FIG. 2, though, in the example 300 the time interval 124 is depicted divided into multiple time slots 126. In one or more implementations, the container orchestrator 114 divides the time interval 124 into the time slots 126 based on a number of commands 130 an individual resource 110 is capable of handling over the time interval 124. In other words, the container orchestrator 114 divides the time interval 124 into a number of time slots 126 that corresponds to the number of commands 130 that the resource 110 is capable of handling over the time interval. Additionally or alternatively, the number of commands 130 that the resource 110 is capable of handling over the time interval 124 corresponds to a maximum number of containers that the container orchestrator 114 can assign to the individual resource 110, in one or more implementations. In at least one variation, once the maximum number of containers 104 is assigned to the resource 110 (or once some threshold relative to the maximum is reached), the container orchestrator 114 assigns containers 104 to a different one of the resources 110.

In a scenario where the resource 110 is a graphics processing unit rendering frames for containers 104 supporting a 30 Hertz refresh rate, for instance, the number of time slots 126 that the 33.333 millisecond time interval 124 is divided into depends on a number of frames that the graphics processing unit is capable of rendering during the 33.333 millisecond time interval 124. In a scenario where a graphics processing unit is capable of rendering 180 frames during a 33.333 millisecond time interval 124, in at least one variation, the container orchestrator 114 divides the time interval 124 into 180 time slots 126. In one or more implementations, the number of time slots 126 into which the container orchestrator 114 divides the time interval 124 is based on different or additional factors. By way of example, the container orchestrator 114 may determine the number of time slots 126 in part based on how many commands 130 the resource 110 is capable of handling, and also, in part, based on adding some amount of idle time between handling the command 130. Indeed, the number of time slots 126 into which the time interval 124 is divided is based on different factors in variations without departing from the spirit or scope of the described techniques.

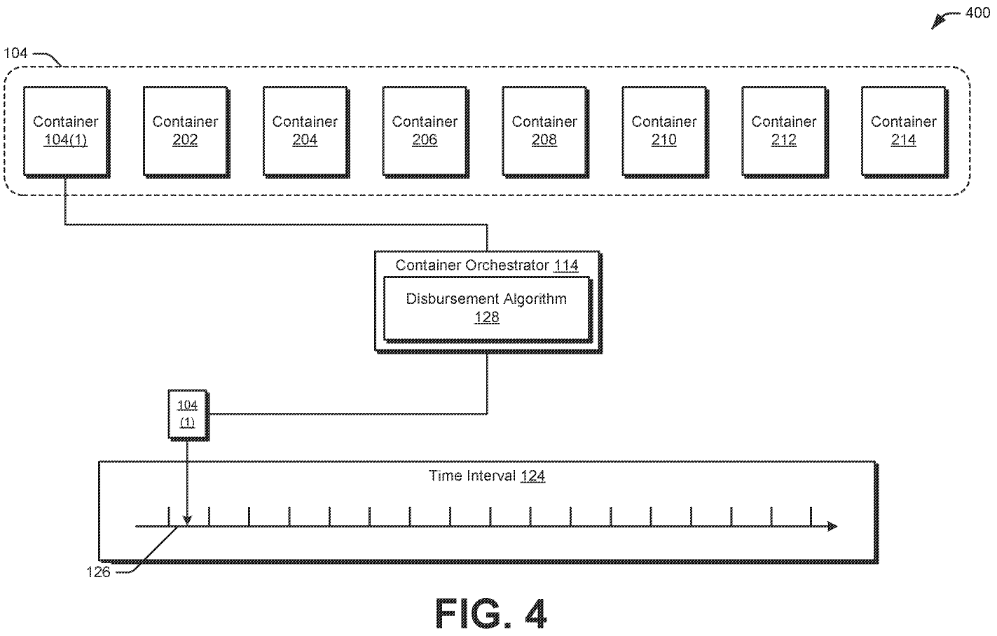

FIG. 4 depicts a block diagram of a non-limiting example 400 of assigning a container to one of the multiple time slots according to the disbursement algorithm.

The illustrated example 400 depicts the group of the containers 104, the container orchestrator 114 having the disbursement algorithm 128, and the time interval 124 divided into the time slots 126. In this example 400, the container orchestrator 114 is depicted assigning the container 104(1) to one of the time slots 126. In particular, the container orchestrator 114 assigns the container 104(1) to a time slot 126 according to the disbursement algorithm 128. In this example 400, the container orchestrator 114 is depicted assigning the container 104(1) to a first time slot 126 of the time interval 124. In one or more implementations, the first time slot 126 corresponds to a signal offset 122 of zero (0) from a baseline signal, e.g., relative to which the offsets are computed. In other words, a container 104 assigned to the first time slot 126 sends its commands 130 on the baseline signal every time interval.

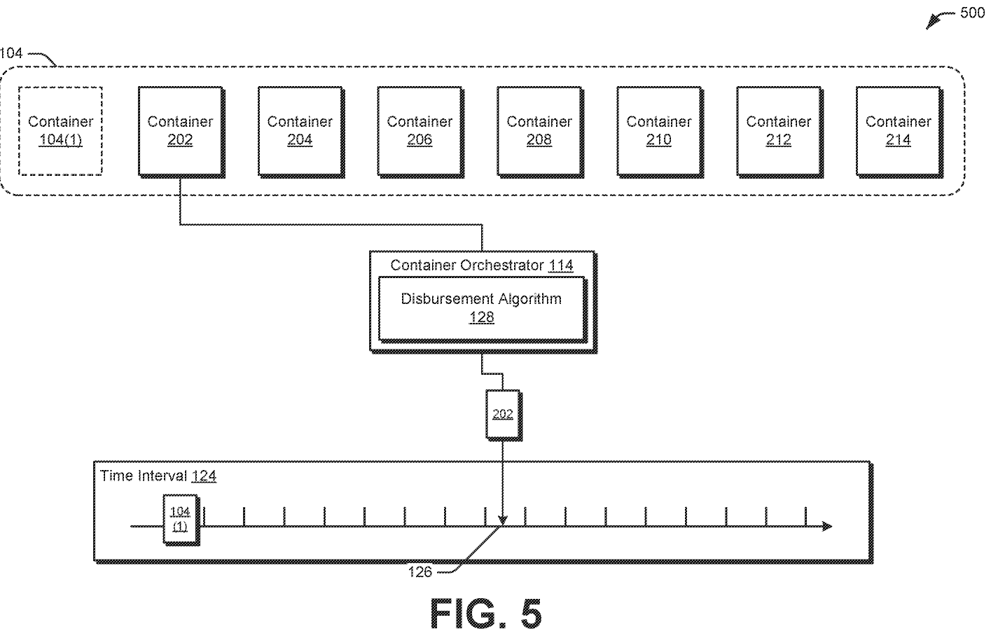

FIG. 5 depicts a block diagram of a non-limiting example 500 of assigning an additional container to a different one of the multiple time slots according to the disbursement algorithm.

In this example 500, the container 104(1) is depicted already assigned to a time slot 126. Further, the container orchestrator 114 is depicted assigning an additional container, e.g., the container 202, to a different one of the time slots 126 than the time slot 126 of the container 104(1). In particular, the container orchestrator 114 assigns the container 202 to the different time slot 126 based on the disbursement algorithm 128.

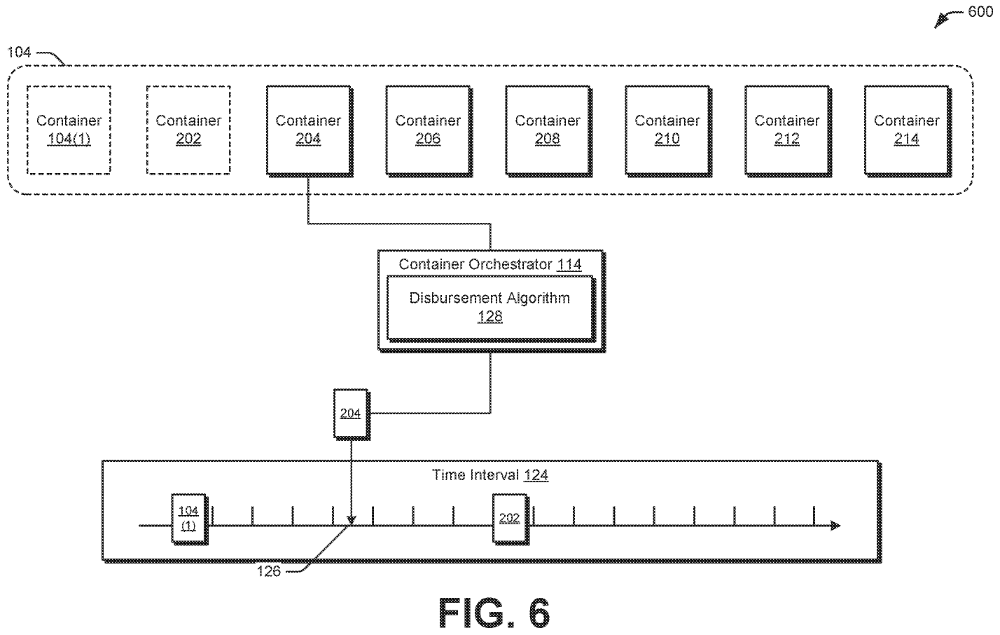

FIG. 6 depicts a block diagram of another non-limiting example 600 of assigning an additional container to a different one of the multiple time slots according to the disbursement algorithm.

In this example 600, the container 104(1) and the container 202 are depicted already assigned to respective time slots 126. Further, the container orchestrator 114 is depicted assigning another additional container, e.g., the container 204, to a different one of the time slots 126 than the time slots 126 of the container 104(1) or of the container 202. In accordance with the described techniques, the container orchestrator 114 assigns the container 204 to the different time slot 126 based on the disbursement algorithm 128.

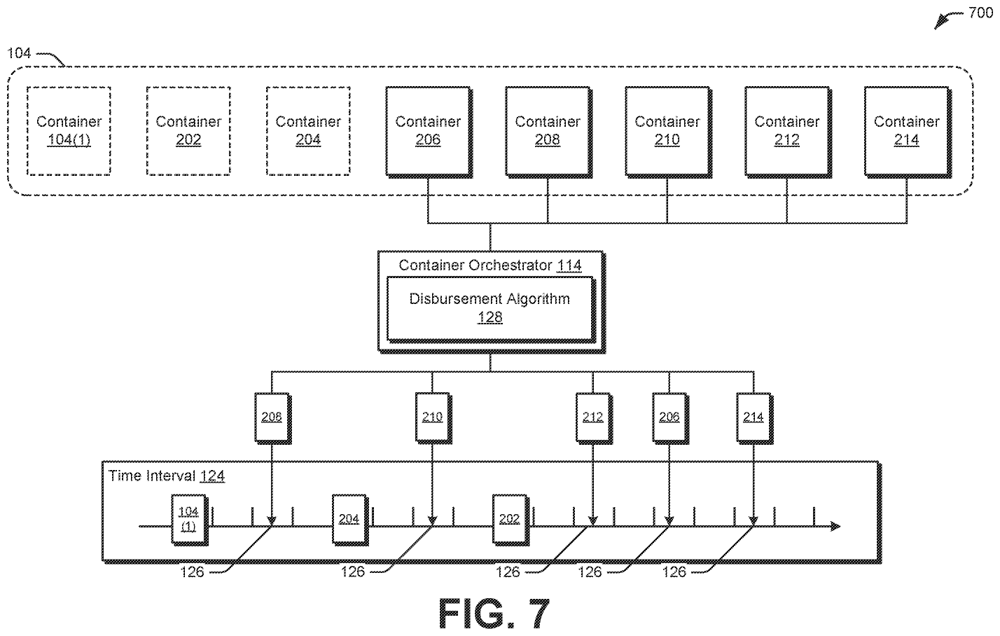

FIG. 7 depicts a block diagram of a non-limiting example 700 of assigning multiple additional containers to different respective time slots according to the disbursement algorithm.

In this example 700, the container 104(1), the container 202, and the container 204 are depicted already assigned to respective time slots 126. Further, the container orchestrator 114 is depicted assigning multiple additional containers, e.g., the containers 206-214, to respective time slots 126 that are different from the time slots 126 of the container 104(1), the container 202, or the container 204. As mentioned above and below, the container orchestrator 114 assigns the containers 206-214 to the respective time slots 126 based on the disbursement algorithm 128.

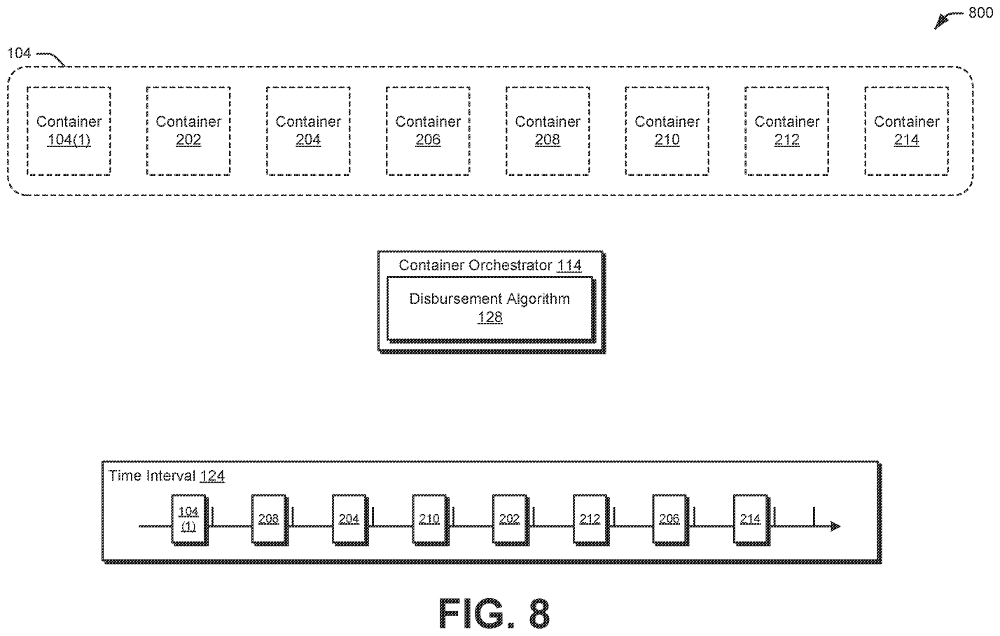

FIG. 8 depicts a block diagram of a non-limiting example 800 of assignment of multiple containers to respective time slots of a time interval according to the disbursement algorithm.

In this example 800, the container 104(1) and the containers 202-214 are depicted assigned to respective time slots 126. In accordance with the described techniques, each of the time slots 126 is associated with a signal offset 122 from a baseline signal. The container orchestrator 114 computes the signal offsets 122 based on the time slots 126, e.g., the number of time slots 126 into which the time interval 124 is divided and which time slot 126 a container 104 is associated with.

In this example, the containers 104(1), 202, 204, 206, 208, 210, 212, 214 are depicted being assigned to evenly spaced time slots 126. The signal offsets 122 provided to those containers 104 further cause the containers to submit their respective commands 130 in an evenly spaced manner over the time interval 124. An evenly spaced manner is one example of a “predetermined order”. In this way, the resource 110 receives the commands 130 in an evenly spaced manner and can execute them to provide the data 132 back to the containers 104 in an evenly spaced manner.

Due to the predetermined order, the container orchestrator 114 causes the resource 110 to be accessed at predetermined times, rather than randomly as is the case with conventional systems. By orchestrating the use of the resource 110 in this way, the container orchestrator 114 regulates when the resource 110 is used (e.g., performing operations) and when the resource 110 operates in a reduced or idle state. Where access to the resource 110 is not managed in this way and where commands are received at random, conventional systems need to store commands (e.g., in a buffer) at times, such as when several commands have been received and the resource has not finished executing a command even though one or more additional commands are also received. At other times, though, the resource of a conventional system may switch to a reduced power mode or state (e.g., to an idle state) because it has not been used for a threshold amount of time. Because commands are submitted by containers at random times in conventional approaches, there is not a definitive time when the resource is scheduled to be used again. As a result, conventional approaches lead to latencies since the resources switch from reduced-power modes to operational modes responsive to receiving a next command randomly—a next command may be received after an unknown amount of idle or reduced power time.

By controlling access by the containers 104 to the resources 110 according to a predetermined order, the container orchestrator 114 is able to regulate the resources 110 so that they do not switch to reduced-power or idle states, or, if they do switch, then the resources 110 can be switched back to an operational state in a suitable amount of time to avoid latencies. Moreover, by allocating a predetermined amount of time for each command 130 and by allocating the amount of time at the predetermined repeated time interval 124, the system 100 guarantees a quality of service of the underlying resources 110 to the containers 104, and, therefore, also to the computing devices 102. Due to this, the resource 110 consistently serves each of the containers 104 with a minimal (but expected) amount of delay, if any.

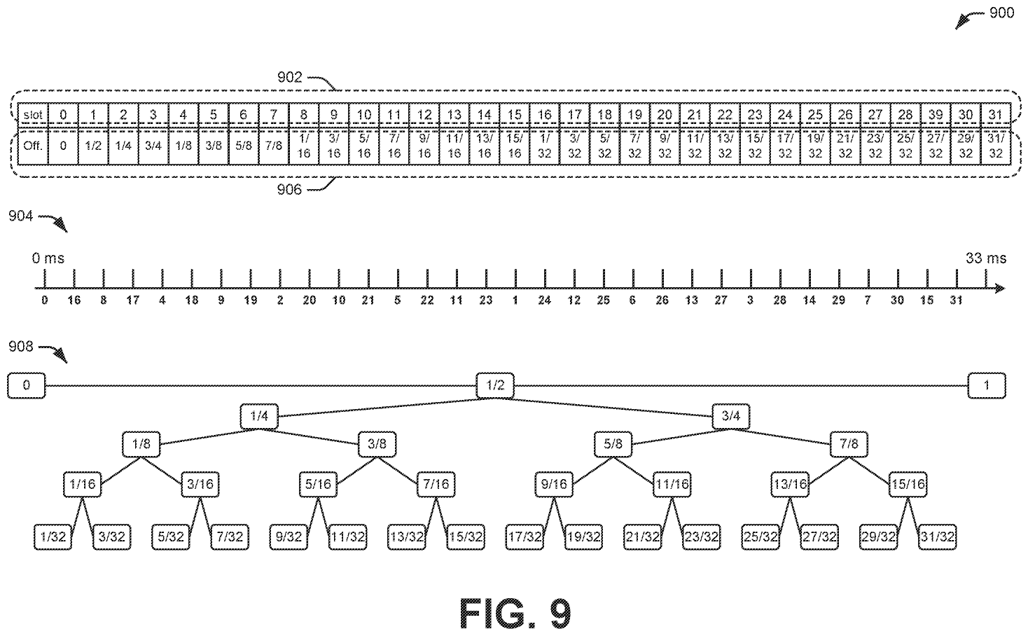

FIG. 9 depicts a block diagram of a non-limiting example 900 of a disbursement algorithm.

In particular, the example 900 depicts a variation in which the disbursement algorithm 128 is configured based on a binary tree (or binary search). Although the illustrated example 900 depicts a binary-tree-based implementation, in variations, the disbursement algorithm 128 is configured according to a different underlying scheme, such as first in, first out (FIFO), assignment of the containers 104 to even time slots 126 then to odd ones (or vice versa), and assignment of the containers 104 to every x^{th} time slot, to name just a few.

The illustrated example 900 depicts a number of time slots 902 for an example time interval 904. For each of the time slots 902, the illustrated example 900 also includes an offset factor 906, which is based on the number of time slots 126 of the time interval 124 and the binary-tree-based implementation.

In this particular example 900, the time interval 904 corresponds to approximately 33 milliseconds (e.g., 33.333 milliseconds), which in one or more implementations supports a refresh rate of 30 frames per second (FPS) for the containers 104, and, by extension, for the computing devices 102. Additionally, the container orchestrator 114 has divided the time interval 904 into 32 time slots in this example 900. As noted above, the number of time slots 902 is based, in part, on how many commands 130, having a same type (e.g., rendering a frame), a given resource 110 can handle over the time interval 904. Although 32 time slots 902 are depicted in this example 900, in variations, the container orchestrator 114 divides the time interval 904 into more time slots, e.g., because the resource 110 is capable of executing more than 32 of the commands in 33.333 milliseconds.

Here, the time slots 902 are each depicted with a unique integer. In one or more implementations, the container orchestrator 114 associates each of the time slots 126 with a unique integer from zero to n−1, where n corresponds to the number of time slots 126 into which the time interval 124 is divided. Further, the time slots 902 are each depicted with a respective offset factor 906. In at least one variation, the offset factors 906 are assigned to the time slots 902 based on a binary tree, where the lowest level of the binary tree has a denominator that is a power of two and is determined such that the number of time slots 902 is greater than a number of nodes above the lowest level of the binary tree and is less than or equal to the number of nodes of the entire binary tree. Given this, a next level of nodes of the binary tree, has a denominator of ‘64’, e.g., if the container orchestrator 114 divided a time interval 124 into more than 33 time slots.

The illustrated example 900 also includes an example binary tree 908, based, at least in part, on which the offset factors 906 are calculated. In operation, the container orchestrator 114 determines the 122 to assign to a container 104 based on the respective offset factor 906. By way of example, the container 104 corresponding to the first slot (e.g., slot[0]) has an offset factor of ‘0’. The container orchestrator 114 computes the signal offset 122 for this container 104 by multiplying the offset factor 906 by the time interval (e.g., 0×33.333 milliseconds (or 33,333,333 nanoseconds)), which produces a signal offset 122 of 0 nanoseconds. In other words, the container 104 that corresponds to the first time slot (e.g., slot[0]) has no offset from the baseline signal, so the container 104 submits its commands 130 at the baseline signal. By way of contrast, the container 104 corresponding to the second slot (e.g., slot[1]) has an offset factor of ‘½’. The container orchestrator 114 computes the signal offset 122 for this container 104 by multiplying the offset factor 906 by the time interval (e.g., ½×33.333 milliseconds (or 33,333,333 nanoseconds)), which produces a signal offset 122 of about 16,666,667 nanoseconds. In other words, the container 104 that corresponds to the second time slot (e.g., slot[1]) is offset from the baseline signal by 16,666,667 nanoseconds, so the container 104 submits its commands 130 at 16,666,667 nanoseconds after the baseline signal. Further still, the container 104 corresponding to the third slot (e.g., slot[2]) has an offset factor of ‘¼’. The container orchestrator 114 computes the signal offset 122 for this container 104 by multiplying the offset factor 906 by the time interval (e.g., ¼ 33.333 milliseconds (or 33,333,333 nanoseconds)), which produces a signal offset 122 of about 8,333,333 nanoseconds. In other words, the container 104 that corresponds to the third time slot (e.g., slot[2]) is offset from the baseline signal by 8,333,333 nanoseconds, so the container 104 submits its commands 130 at 8,333,333 nanoseconds after the baseline signal. This process repeats in accordance with the illustrated table.

In one or more implementations, the signal offset 122 of a container 104 defines the vertical synchronization signal (or vsync signal) for the container 104. Broadly, a vsync signal synchronizes a frame rate of an application 108 (e.g., a gaming application) with a display's refresh rate, such as a display of a respective computing device 102. In accordance with the described techniques, in a gaming implementation, the containers 104 submit the commands 130 to an assigned resource 110 (e.g., a graphics processing unit) at their respective vsync signal, which is defined based on the signal offset 122 from a baseline signal for a group of containers that share a resource 110.

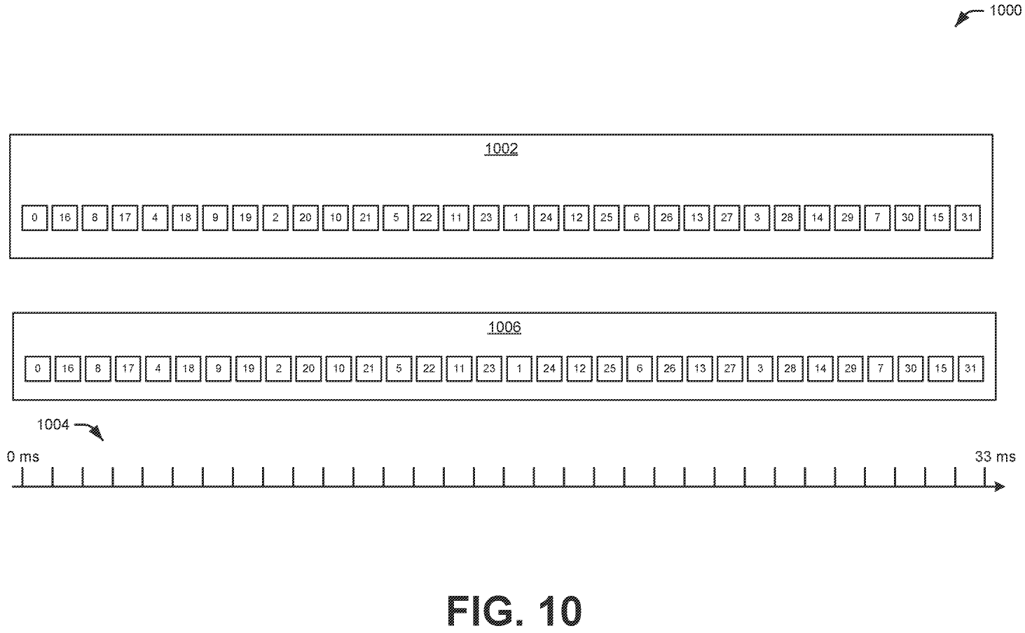

FIG. 10 depicts a block diagram of a non-limiting example 1000 of receiving render commands from multiple containers for an application in a predetermined order.

The illustrated example 1000 includes a representation 1002 of when a plurality of rendering commands are submitted by a plurality of containers over a time interval 1004 to a resource 110 that they share, in accordance with the described techniques. The illustrated example 1000 also includes a representation 1006 of when the rendering commands are executed, or otherwise handled, by the resource 110 in relation to the time interval 1004.

This example 1000 represents how the container orchestrator 114 orchestrates the submission of commands 130 by a plurality of containers to a resource 110 so that the commands are submitted and executed in a predetermined order. As a result, the resource 110 is accessed by the containers 104 in a way that consistently uses the resource 110, rather than randomly overburdening the resource sometimes and leaving it in a reduced power or idle state at other times (such that the resource must ramp back up to an operational state in order to execute commands).

By way of contrast to this example 1000, consider the following example, in which commands are submitted randomly by containers, e.g., because the timing at which they are allowed to submit commands has not been orchestrated.

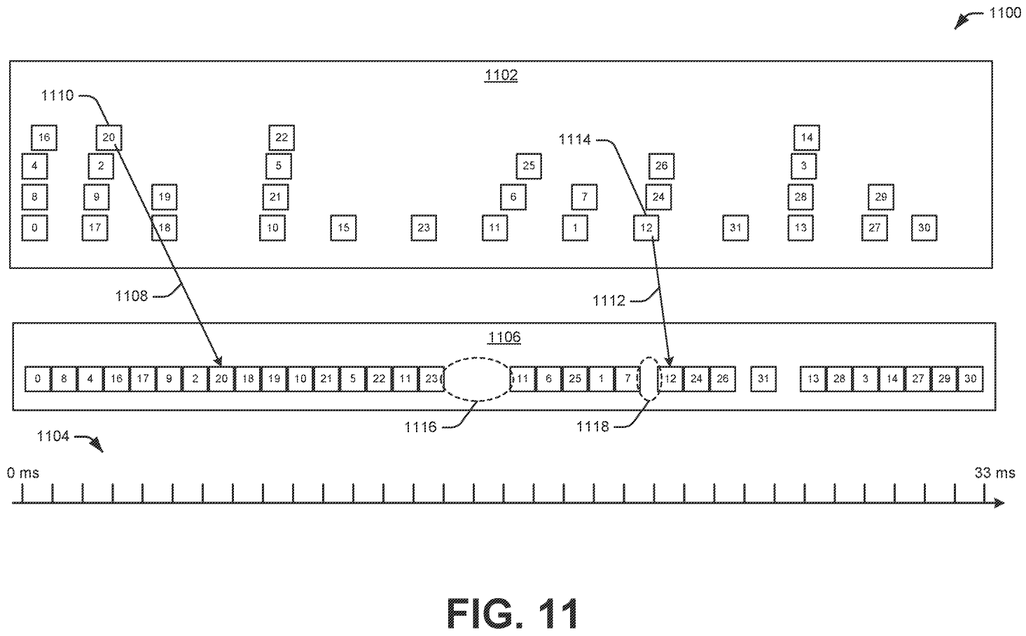

FIG. 11 depicts a block diagram of a non-limiting example 1100 of receiving render commands from multiple containers for an application at random times.

The illustrated example 1100 includes a representation 1102 of when a plurality of rendering commands are submitted by a plurality of containers over a time interval 1104 to a resource that they share, in a manner similar to at least one conventional techniques. The illustrated example 1100 also includes a representation 1106 of when the rendering commands are executed by the resource in relation to the time interval 1104.

Here, the representation 1102 include clusters of commands near some points of time and no commands around other points in time, which contrasts with the relatively even submission of commands depicted in the representation 1002 as orchestrated by the container orchestrator 114. Due to the unevenness of the submitted commands, because conventional techniques allow for random submission of commands for a group of containers using a resource, the timing at which the resource is able to handle the commands is inconsistent. By way of example, there is a relatively long delay 1108 between when the command 1110 is submitted and when the resource is able to execute the command 1110, while there is a relatively short delay 1112 between when the command 1114 is submitted and when the resource is able to execute the command 1114. The illustrated example 1100 also depicts that the resource switches to reduced power or idle states over the time interval, including a longer period of time in the reduced idle state 1116 and a shorter period of time in the reduced idle state 1118. These varying periods of delay for handling commands and varying periods of reduced power or idle state of resources, lead to inconsistent quality of service for various containers. Due to the randomness of command submission, conventional systems can fail to provide applications via containers that meet a threshold (e.g., guaranteed) quality of service.

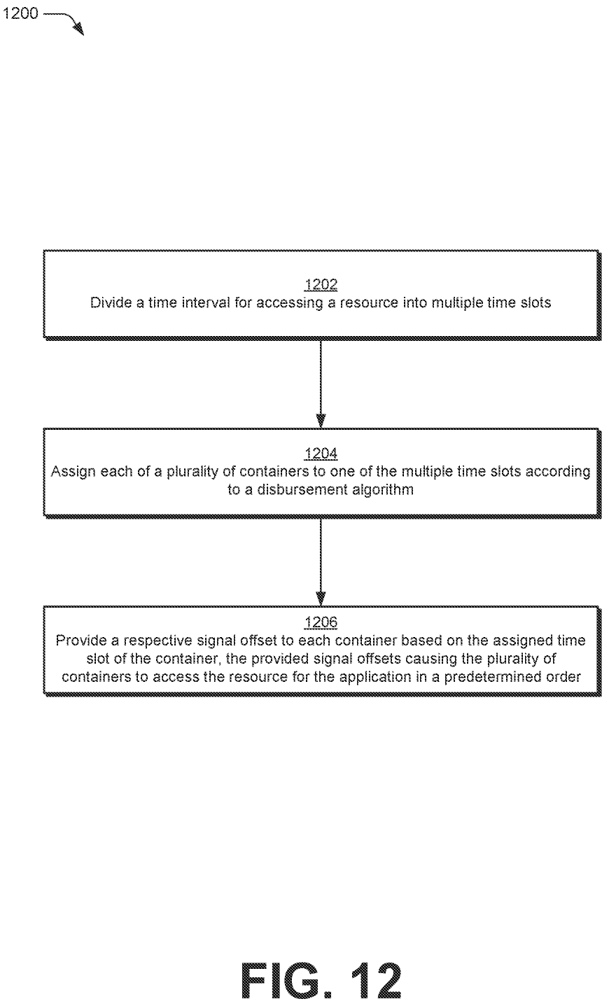

FIG. 12 depicts a procedure 1200 in an example implementation of orchestrating access to a resource by a plurality of containers for an application.

A time interval for accessing a resource is divided into multiple time slots (block 1202). By way of example, the container orchestrator 114 divides a time interval 124 for accessing a resource 110 into multiple time slots 126. Generally, the time interval 124 corresponds to a period of time for one or more operations to be performed for the containers 104 by the resources 110 on a repeated basis. In at least one variation, a number of time slots 126 into which the time interval 124 is divided is based on an amount of time it takes the resource 110 to perform the one or more operations.

Each of a plurality of containers is assigned to one of the multiple time slots according to a disbursement algorithm (block 1204). By way of example, the container orchestrator 114 assigns each of a plurality of containers 104 to one of the multiple time slots 126 according to the disbursement algorithm 128.

A respective signal offset is provided to each container based on an assigned time slot of the container (block 1206). In accordance with the principles discussed herein, the provided signal offsets cause the plurality of containers to access the resource for the application in a predetermined order. By way of example, the container orchestrator 114 provides a respective signal offset 122 to each container 104 based on the assigned time slot 126 of the container 104. The provided signal offsets 122 specify an offset from a baseline time or signal, and they control when the plurality of containers 104 access the resource 110 in connection with running the application 108.

For a group of containers 104 accessing a same resource 110 (e.g., an individual graphics processing unit), for instance, the container orchestrator 114 provides a different signal offset 122 to each container 104. With the signal offsets 122, the container orchestrator 114 controls when the containers 104 access the resource 110. By providing a different signal offset 122 to each container 104, the container orchestrator 114 causes the containers 104 to access a resource 110 at different times relative to the baseline time or signal, such as in a predetermined order.

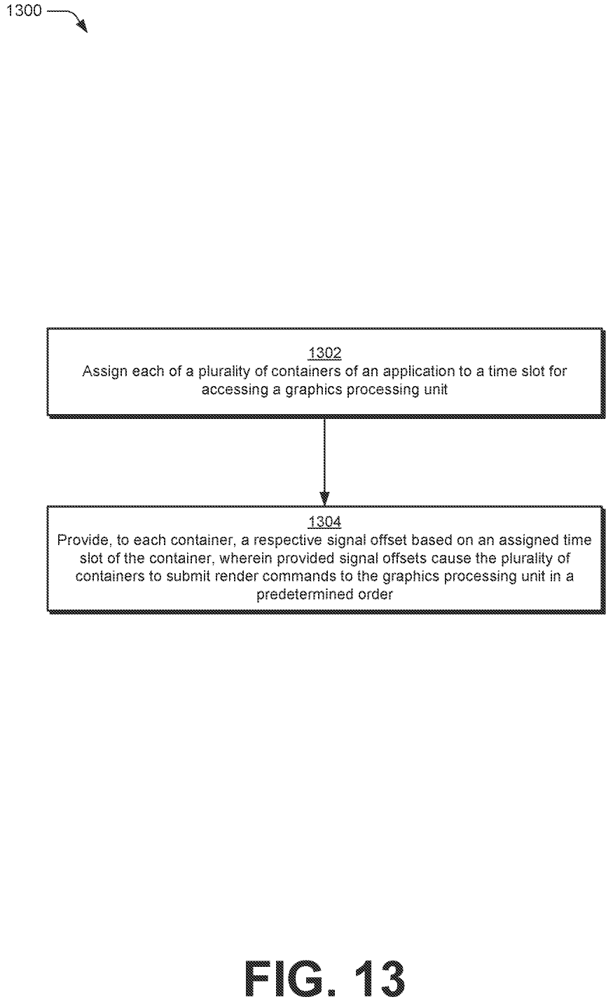

FIG. 13 depicts a procedure 1300 in an example implementation of orchestrating access by a plurality of containers of an application to a graphics processing unit.

Each of a plurality of containers of an application is assigned to a time slot for accessing a graphics processing unit (block 1302). By way of example, the container orchestrator 114 assigns each of a plurality of containers 104 of an application 108 to a time slot 126 for accessing a graphics processing unit. In one or more implementations, the application comprises a gaming application and the containers 104 are assigned to the time slots 126 in order to submit rendering commands to graphics processing unit.

A respective signal offset is provided to each container based on an assigned time slot of the container (block 1304). In accordance with the principles discussed herein, the provided signal offsets cause the plurality of containers to submit render commands to the graphics processing unit in a predetermined order. By way of example, the container orchestrator 114 provides a respective signal offset 122 to each container 104 based on the assigned time slot 126 of the container 104. The provided signal offsets 122 specify an offset from a baseline time or signal, and control when the plurality of containers 104 access the graphics processing unit, e.g., by submitting render commands to the graphics processing unit. For a group of containers 104 accessing the same graphics processing unit, for instance, the container orchestrator 114 provides a different signal offset 122 to each container 104. With the signal offsets 122, the container orchestrator 114 controls when the containers 104 access the graphics processing unit. By providing a different signal offset 122 to each container 104, the container orchestrator 114 causes the containers 104 to access the graphics processing unit at different times relative to the baseline time or signal, such as in a predetermined order.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the containers 104, the resources 110, the container manager 112, the container orchestrator 114, the resource kernel-mode driver 116, and the resource user mode driver 118) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method for orchestrating access to a resource for a plurality of containers for an application, the method comprising:
dividing a time interval for accessing the resource into multiple time slots;
assigning each of the plurality of containers to one of the multiple time slots according to a disbursement algorithm; and
providing, to each container, a respective signal offset based on an assigned time slot of the container, wherein provided signal offsets cause the plurality of containers to access the resource for the application in a predetermined order.

2. The method of claim 1, wherein the provided signal offsets specify an offset from a baseline signal.

3. The method of claim 1, wherein the disbursement algorithm causes the plurality of containers to be assigned to evenly spaced time slots over the time interval.

4. The method of claim 1, wherein the disbursement algorithm is configured based on binary tree.

5. The method of claim 1, wherein each of the multiple time slots is associated with an offset factor, and wherein the signal offset is determined based on the offset factor.

6. The method of claim 1, further comprising assigning the plurality of containers to the resource based on computing devices of the plurality of containers having a same refresh rate or frame per second criteria.

7. The method of claim 6, further comprising determining the time interval for accessing the resource based on the refresh rate.

8. The method of claim 1, wherein the dividing the time interval into multiple time slots is based on a maximum number of containers that can access the resource during the time interval.

9. The method of claim 1, wherein the provided signal offsets cause the plurality of containers to access the resource by sequentially submitting commands to the resource.

10. The method of claim 9, wherein the resource executes the commands in substantially real time as the commands are submitted to the resource.

11. A system comprising:
a resource for an application; and
a container orchestrator that orchestrates access to the resource by a plurality of containers for the application by providing, to each container of the plurality of containers, a respective signal offset, wherein provided signal offsets cause the plurality of containers to access the resource for the application in a predetermined order.

12. The system of claim 11, wherein the resource comprises a graphics processing unit.

13. The system of claim 12, wherein the application comprises a gaming application.

14. The system of claim 11, wherein the provided signal offsets specify an offset from a baseline signal.

15. The system of claim 11, wherein the provided signal offsets cause the plurality of containers to access the resource by sequentially submitting commands to the resource, and wherein the resource executes the commands in substantially real time as the commands are submitted to the resource.

16. A method for orchestrating access by a plurality of containers to a graphics processing unit to render an application, the method comprising:
assigning each of the plurality of containers of the application to a time slot for accessing the graphics processing unit; and
providing, to each container, a respective signal offset based on an assigned time slot of the container, wherein provided signal offsets cause the plurality of containers to submit render commands to the graphics processing unit in a predetermined order.

17. The method of claim 16, wherein the assigning further comprises dividing a time interval for accessing the graphics processing unit into multiple time slots.

18. The method of claim 16, wherein providing the respective signal offset causes each container to store the signal offset with configuration data of the container.

19. The method of claim 16, wherein application comprises a gaming application.

20. The method of claim 16, wherein the provided signal offsets define a vertical synchronization signal for each respective container.
